(19) United States
(12) Patent Application Publication
(10) Pub. No.: US 2008/0068477 A1
(43) Pub. Date: Mar. 20, 2008

(54) SOLID-STATE IMAGING DEVICE

(75) Inventors: Yoshinori IIDA, Tokyo (JP); Hiroto Honda, Tokyo (JP); Yoshitaka Egawa, Yokohama-Shi (JP); Goh Itoh, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/690,364

(22) Filed: Mar. 23, 2007

(30) Foreign Application Priority Data
Sep. 20, 2006 (JP) 2006-254732

(51) Int. Cl. H04N 3/14

(52) U.S. Cl. 348/294; 348/E03.016

(57) ABSTRACT

This disclosure concerns a solid-state imaging device comprising plurality of first pixels each including a colorless filter to convert the visible light into a first electric signal; plurality of second pixels each including a first filter having a peak of a spectral transmission at a first wavelength of the visible light to convert the visible light at the first wavelength into a second electric signal; plurality of third pixels each including a second filter having a peak of a spectral transmission at a second wavelength other than the first wavelength of the visible light to convert the visible light at the second wavelength into a third electric signal; and an arithmetic part receiving the first to the third electric signals and calculating a fourth electric signal corresponding to a third wavelength other than the first wavelength and the second wavelength by using the first to the third electric signals.

### CROSS-REFERENCE TO RELATED APPLICATION

This application is based upon and claims the benefit of priority from the prior Japanese Patent Application No. 2006-254732, filed on Sep. 20, 2006, the entire contents of which are incorporated herein by reference.

### BACKGROUND OF THE INVENTION

1. Field of the Invention

The present invention relates to a solid-state imaging device.

2. Related Art

As a solid-state imaging device, development of a CMOS (Complimentary Metal-Oxide Semiconductor) image sensor is underway. Following reduction in design rule in semiconductor process, a single-chip color image sensor constituted by more than five-mega pixels each about 2.5 μm square has been commercialized. Furthermore, as a CCD (charge-coupled device), a digital still camera using a single-chip color image sensor constituted by pixels each about 1.86 μm square has been commercialized.

In the single-chip color image sensor, a CFA (Color-Filter-Array) referred to as “Bayer Array” is formed in a pixel region to acquire color image information by one chip. The Bayer array is configured so that two green (G) pixels are arranged diagonally and a red (R) pixel and a blue (B) pixel are arranged as remaining two pixels in a pixel block of two rows by two columns. The Bayer array is adopted as the most commonly used CFA array. The green, red, and blue pixels are pixels that receive a green light, a red light, and a blue light and that output electric signals based on their light intensities, respectively. The reasons that the Bayer array is adopted as the most commonly used CFA array are as follows.

The green (G) is a color that has the greatest influence on human's visual sensitivity among all visible lights. A luminance signal Y according to television specification is expressed by Equation 1.

Y=0.299R+0.587G+0.114B (Equation 1)

In the Equation 1, G represents the light intensity of the green light, R represents that of the red light, and B represents that of the blue light. The light intensity indicates a voltage or current of an electric signal which a pixel generates by the photoelectric effect when the pixel receives a light having certain intensity. As can be understood from the Equation 1, the luminance signal Y according to the television specification is constituted so that the green light gives the largest contribution thereto (JP-A H8-9395 (KOKAI)).

Accordingly, by increasing the ratio of green pixels and arranging the green pixels checkerwise, the Bayer array can obtain a higher-level luminance signal Y and increase the resolution of the luminance signal Y.

Moreover, a CFA array in which all RGB pixels and visible light pixels W are used is disclosed in JP-A 2004-304706 (KOKAI).

According to the definition of JIS-Z8120, the wavelength of an electromagnetic wave corresponding to a visible ray is about 360 nm to 400 nm on short-wavelength side and about 760 nm to 830 nm on long-wavelength side. An ordinary image sensor images a visible ray in a wavelength range of about 400 nm to 700 nm.

In the single-chip color image sensor that adopts the Bayer array as the CFA, the green pixel includes a filter that transmits a green component in an incident light and that absorbs a red component and a blue component in the incident light. In a case that the green-transmittable filter is used, the peak of the transmittance of the green-transmittable filter is reduced to about 80% of the incident light. Therefore, utilization ratio of the green component in the incident light is conventionally up to 80%. Utilization ratios of the red component and the blue component are conventionally about 95% and 80%, respectively.

Meanwhile, the quantity of the incident light is reduced following miniaturization of pixels. This signifies that the sensitivity of a solid-state imaging device having the miniaturized pixels is deteriorated, when the device images a low-illuminance object.

If an object is to be imaged into a color image, it is necessary to acquire and reproduce three types of color information different in wavelength so as to reproduce color information on the object. However, as described, the transmittance of each color filter for acquiring the three types of color information is about 80% to 95%, so that the incident light cannot be made effective use of. Furthermore, as long as the color filter that transmits monochromatic light is used, optical energies of the two other colors are absorbed by the color filter and lost. Namely, the solid-state imaging device using color filters corresponding to RGB, respectively, is low in sensitivity, when the device images the low-illuminance object.

### SUMMARY OF THE INVENTION

A solid-state imaging device according to an embodiment of the present invention comprises a plurality of first pixels each including a colorless filter substantially transmitting a visible light at all wavelengths to convert the visible light into a first electric signal; a plurality of second pixels each including a first filter having a peak of a spectral transmission at a first wavelength of the visible light to convert the visible light at the first wavelength into a second electric signal; a plurality of third pixels each including a second filter having a peak of a spectral transmission at a second wavelength other than the first wavelength of the visible light to convert the visible light at the second wavelength into a third electric signal; and an arithmetic part calculating a fourth electric signal corresponding to a third wavelength other than the first wavelength and the second wavelength by using the first to the third electric signals.

A solid-state imaging device according to an embodiment of the present invention comprises a plurality of first pixels each including a colorless filter substantially transmitting a visible light at all wavelengths to convert the visible light into a first electric signal; a plurality of second pixels each including a first filter having a peak of a spectral transmission at a first wavelength of the visible light to convert the visible light at the first wavelength into a second electric signal; a plurality of third pixels each including a second filter having a peak of a spectral transmission at a second wavelength other than the first wavelength of the visible light to convert the visible light at the second wavelength into a third electric signal; and an arithmetic part receiving the first to the third electric signals generated by a light incident on a pixel region constituted by the first pixels to the third pixels, the arithmetic part generating a luminance signal and a color-difference signal for one of the first to the third pixels by using the first to the third electric signals.

### BRIEF DESCRIPTION OF THE DRAWINGS

FIG. 1 is a block diagram showing a solid-state imaging device according to a first embodiment of the present invention;

FIG. 2 is a plane view showing an imaging region 101;

FIG. 3 is a graph optical transmittances of color filters;

FIG. 4 is a graph of spectral sensitivity characteristics of the respective pixels;

FIG. 5 is a graph showing decisions of a subtraction method and a division method;

FIG. 6 is a graph showing a relationship between the signal outputs and the illuminance;

FIG. 7 is a flow chart showing a process generating signals SR, SG and SB;

FIG. 8 is a flow chart showing a process generating signals SY, SU and SV;

FIG. 9 is a schematic showing a modification of a pixel arrangement;

FIG. 10 is a schematic showing a modification of a pixel arrangement;

FIG. 11 is a schematic showing a modification of a pixel arrangement;

FIG. 12 is a schematic showing a modification of a pixel arrangement;

FIG. 13 is a schematic showing a modification of a pixel arrangement; and

FIG. 14 is a schematic showing a modification of a pixel arrangement.

### DETAILED DESCRIPTION OF THE INVENTION

Embodiments of the present invention will be explained below with reference to the accompanying drawings. The present invention is not limited to the embodiments.

### First Embodiment

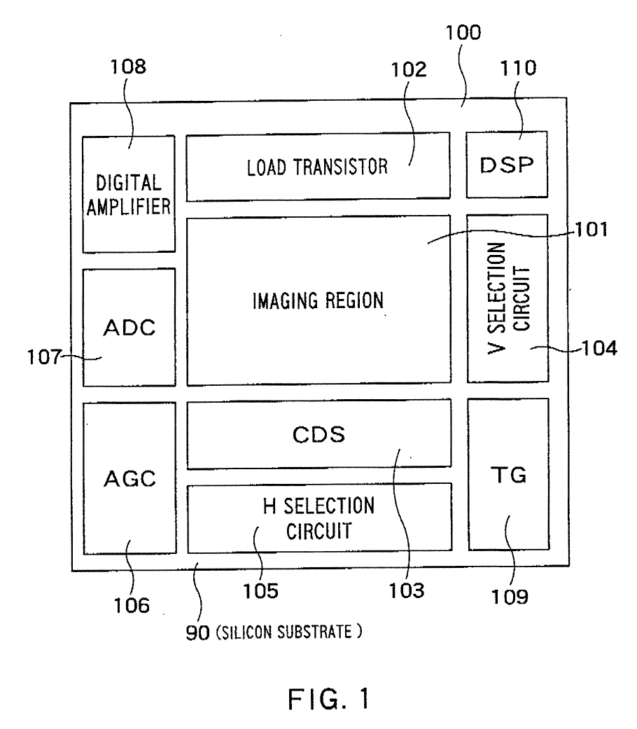

A solid-state imaging device 100 shown in FIG. 1 includes a silicon substrate 90, an imaging region 101, a load transistor 102, a CDS (Correlated Double Sampling) circuit 103, a V (Vertical) selection circuit 104, an H (Horizontal) selection circuit 105, an AGC (Automatic Gain Controller) 106, an ADC (Analog-Digital Converter) 107, a digital amplifier 108, a DSP (Digital Signal processor) 110, and a TG (Timing Generator) 109. These constituent elements of the solid-state imaging device 100 are formed on one semiconductor chip. The ADC 107 and the CDS circuit 103 can be integrally constituted as a column CDS-ADC circuit.

The imaging region 101 includes a plurality of pixels each converting an incident light into an electric signal by photoelectric conversion. The pixels are arranged in a two-dimensional matrix. The load transistor 102, which is connected between a substrate potential (not shown) and the imaging region 101, functions as a current source that supplies constant current to the pixels in the imaging region 101. The V selection circuit 104 selects specific pixels in the imaging region 101 and transmits electric signal generated in the selected pixels to the CDS circuit 103. The CDS circuit 103 is a circuit that eliminates amplifier noise and reset noise from the electric signal obtained from the imaging region 101. The H selection circuit 105 outputs signals from the CDS circuit 103 at time series. The AGC circuit 106 controls the amplitude of each signal from the CDS circuit 103. The ADC 107 converts an analog signal from the CDS 103 into a digital signal. The digital amplifier 108 amplifies the digital signal and outputs the amplified digital signal. The TG 109 is a circuit that controls timings of operations performed by the load transistor 102, the CDS circuit 103, the V selection circuit 104, the H selection circuit 105, the AGC 106, the ADC 107, and the digital amplifier 108. Furthermore, the DSP 110 performs digital processings such as interpolation, decision, color processing, and color signal extraction. Namely, the DSP 110 generates RGB signals or YUV signals from the digital signals. The DSP 110 can be provided separately from the solid-state imaging device 100 or included in a chip of the solid-state imaging device 100. Moreover, the TG 109, the AGC 106, the ADC 107, the digital amplifier 108 and the like can be formed on a different chip of the solid-state imaging device 100. Further, a signal processing circuit, which is not shown in FIG. 1, can be mounted on the chip of the solid-state imaging device 100.

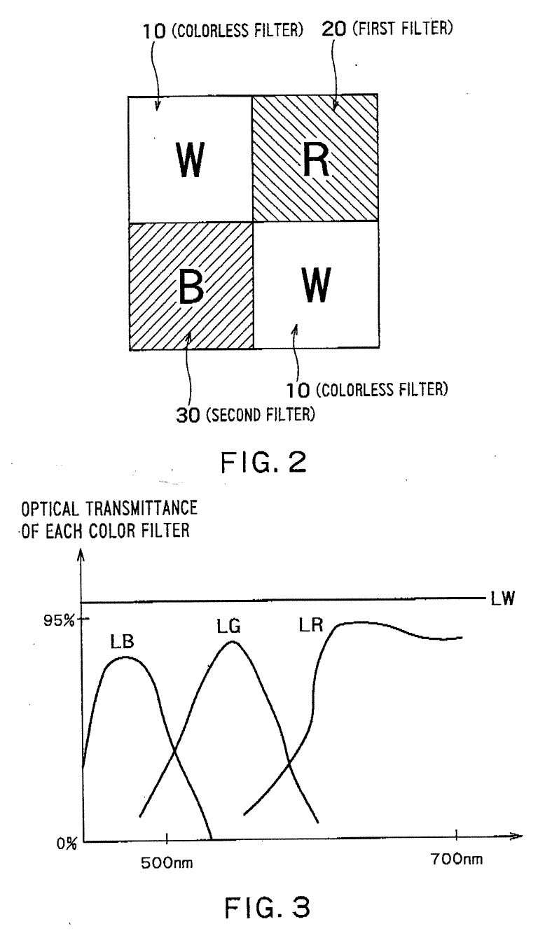

With reference to FIG. 2, a first pixel W includes a colorless filter 10 that transmits visible lights at all wavelengths. The first pixel W converts each visible light into a first electric signal. A second pixel R includes a first filter 20 having a spectral transmission peak at the wavelength of a red light among the visible lights The second pixel R converts the red light at the wavelength into a second electric signal. A third pixel B includes a second filer 30 having a peak spectral transmission at the wavelength of a blue light among the visible lights. The third pixel B converts the blue light at the wavelength into a third electric signal.

The four-pixel block shown in FIG. 2 is constituted by two first pixels W, one second pixel R, and one third pixel B. The imaging region 101 is constituted by periodically repeating units each of which consists of the four-pixel block. Thus, the first pixels W are arranged checkerwise. The second pixel R and the third pixel B are alternately arranged between two adjacent first pixels W.

In the imaging region 101 where the CFA is thus arranged, the pixels are arranged in order of W, R, W, R . . . in the n^{th} row, in order of B, W, B, W . . . in the (n+1)^{th} row, and in order of W, R, W, R . . . in the (n+2)^{th} row. The solid-state imaging device 100 outputs electric signals for the respective pixels according to the array.

If signals obtained from the pixels W are extracted from this array, signals are arranged in order of SW, *, SW, * . . . in the n^{th} row, in order of *, SW, *, SW . . . in the (n+1)^{th} row, in order of SW, *, SW, . . . in the (n+2)^{th} row, and in order of *, SW, *, SW . . . in the (n+3)^{th} row. If signals obtained from the pixels R are extracted from this array, signals are arranged in order of *, SR, *, SR . . . in the n^{th} row, in order of *, *, *, * . . . in the (n+1)^{th} row, in order of *, SR, *, SR . . . in the (n+2)^{th} row, and in order of *, *, *, * . . . in the (n+3)^{th} row. If signals obtained from the pixels B are extracted from this array, signals are arranged in order of *, *, *, * . . . in the n^{th} row, in order of SB, *, SB, * . . . in the (n+1)^{th} row, in order of *, *, *, * . . . in the (n+2)^{th} row, and in order of SB, *, SB, * . . . in the (n+3)^{th} row. Symbols SW, SR, and SB denote electric signals (voltages or currents) obtained from the first pixel W, the second pixel R, and the third pixel B, respectively. Namely, the SW, SR, and SB denote intensities of the respective visible lights or intensities of the lights of respective colors. Symbol “*” indicates that the intensity of the visible light or the intensity of the light of the corresponding color is unclear. For example, if attention is paid to the signals obtained from the first pixels W, the intensities of visible lights are unknown at positions at which the second pixels R and the third pixels B are arranged. Therefore, “*” is shown at the positions at which the second pixels R and the third pixels B are arranged. If attention is paid to the signals obtained from the second pixels R, the intensity of the red light is unknown at positions at which the first pixels W and the third pixels B are arranged. Therefore, “*” is shown at the positions at which the first pixels W and the third pixels B are arranged. If attention is paid to the signals obtained from the third pixels B, the intensity of the blue light is unknown at positions at which the first pixels W and the second pixels R are arranged. Therefore, “*” is shown at the positions at which the first pixels W and the second pixels R are arranged.

The intensity of the visible light or the intensity of the light of each color denoted by “*” is calculated by the DSP 110 serving as an arithmetic unit by interpolation. As an interpolation method, the DSP 110 may calculate an arithmetic mean among the signals from the pixels in the same CFA adjacent to the pixel of interest vertically, horizontally, and/or diagonally. For example, the intensity of the visible light at the second pixel R is calculated by averaging signals SW from four first pixels W adjacent to the second pixel R vertically and horizontally. The average of the four signals SW can be regarded as the intensity of the visible light at the second pixel R. The intensity of the visible light at the third pixel B can be similarly calculated. The intensity of the blue light at the second pixel R is calculated by averaging the signals SB from four third pixels B adjacent to the second pixel R diagonally. Likewise, the intensity of the red light at the third pixel B is calculated by averaging the signals SR from four second pixels R adjacent to the third pixel B diagonally. Furthermore, the intensity of the red light at the first pixel W is calculated by averaging the signals SR from two second pixels R adjacent to the first pixel W vertically or horizontally. The intensity of the blue light at the first pixel W is calculated by averaging the signals SB from two third pixels B adjacent to the first pixel W vertically or horizontally. By performing such interpolation, three types of color information of the SW, SR, and SB at all pixels in the imaging region can be obtained. This interpolation is performed using the signals from the nine-pixel block in three rows by three columns. However, the number of pixels used for the interpolation can be arbitrarily set according to interpolation capability. Moreover, the interpolation is performed by calculating the arithmetic mean. Alternatively, the method other than the arithmetic mean calculation method can be used.

At this stage, the three types of color information of the signals SW, SR, and SB at the respective pixels are obtained. The signals SR and SB obtained herein are the electric signals for red (R) and blue (B) among three primary colors of light (red (R), green (G), and blue (B)). However, a signal SG for green (G) is still unknown. The DSP 110 calculates the signal SG as a fourth signal using the first electric signal SW, the second electric signal SR, and the third electric signal SB at the respective pixels.

In the graph shown in FIG. 3, the horizontal axis indicates the wavelength of the incident light and the vertical axis indicates the optical transmittance of each color filter. As indicated by a line LW, the colorless filter employed in the first pixel W has a high transmittance higher than 95% at all wavelengths in the visible light range. As indicated by a line LR, the first filter employed in the second pixel R has a spectral transmittance peak at the wavelength of red. The spectral transmittance of the first filer is about 95%. As indicated by a line LB, the second filter employed in the third pixel B has a peak spectral transmittance at the wavelength of blue, and the spectral transmittance thereof is about 80%. As indicated by a line LG, a spectral transmittance of a conventional filer has a spectral transmittance peak at the wavelength of green (hereinafter, “third filter”), and the spectral transmittance thereof is about 80%.

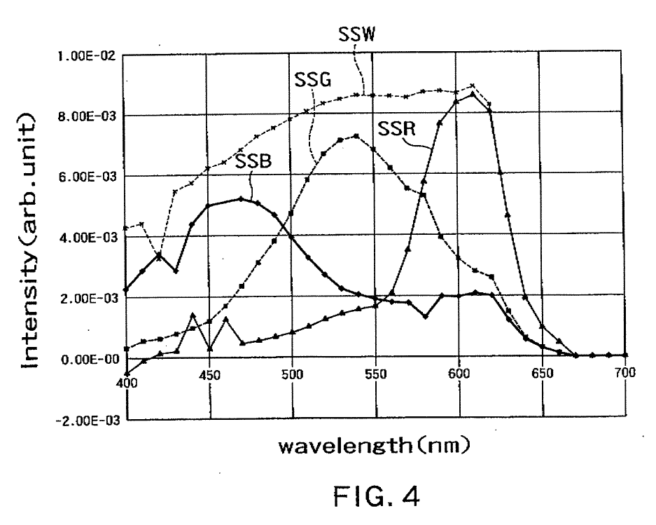

FIG. 4 is a graph showing spectral sensitivity characteristics of the respective pixels each including a color filter shown in FIG. 3. In FIG. 4, the horizontal axis indicates the wavelength of the incident light and the vertical axis indicates the intensity of an optical signal. As shown in FIG. 4, the first pixel W has high spectral sensitivity at all wavelengths of the visible light. As shown in the graph of FIG. 4, a sensitivity SSW of the first pixel W is higher than a sensitivity SSR of the second pixel R, a sensitivity SSB of the third pixel B, and a sensitivity SSG of a pixel including a third filter (hereinafter, “fourth pixel”).

The spectral sensitivity characteristic results from the fact that the transmittances of the first to third filters are lower than that of the colorless filter. If proportional constants decided by the transmittances of the first to third filters and the spectral sensitivity characteristics of the respective pixels are Kr, Kb, and Kg, respectively, the following equation 2 is established.

SW=Kr×SR+Kb×SB+Kg×SG (Equation 2)

In the specific examples shown in FIGS. 3 and 4, the constants Kr, Kb, and Kg are 1.03, 1.23, and 1.23, respectively. The signal SG is expressed by the following equation 3 using these proportional constants Kr, Kb, and Kg.

SG=(SW−Kr×SR−Kb×SB)/Kg=0.82×SW−0.84×SR−SB (Equation 3)

The DSP 110 calculates the signal SG by substituting the signals SW, SR, and SB obtained from the digital amplifier 108 to the equation 3.

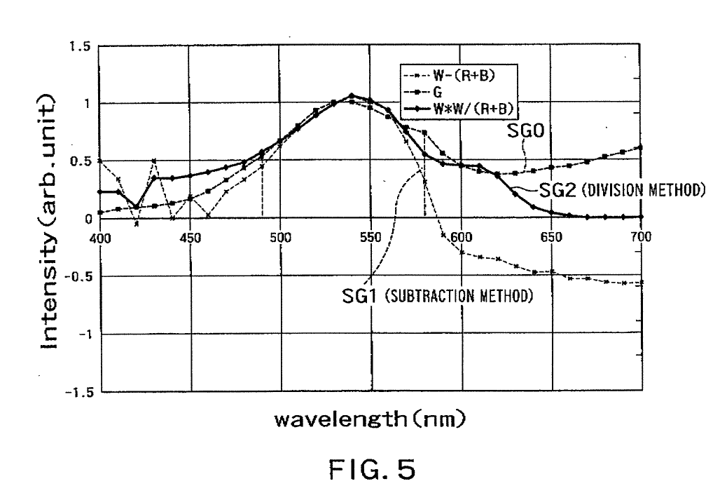

In the first embodiment, the DSP 110 multiplies the second electric signal SR and the third electric signal SB by the coefficients Kr and Kb obtained in view of the transmittance of the first filter and that of the second filter, respectively. The DSP 110 subtracts a first result of the multiplication (SR(Kr)−SB(Kb)) from the first electric signal SW. The DSP 11 divides a second result of the subtraction (SW−SR(Kr)−SB(Kb)) by a coefficient Kg obtained in view of the transmittance of the third filter. The DSP 110 thereby calculates the fourth electric signal SG. As shown in the equation 3, the fourth electric signal SG is obtained by subtracting the component of the red signal SR and that of the blue signal SB from the visible light signal SW. This method will be referred to as “subtraction method” hereinafter. By executing this subtraction method, a signal SG1 shown in FIG. 5 can be obtained. A signal SG0 is obtained by the pixel actually including the third filter. The signal SG1 almost coincides with the signal SG0 in the wavelength range of the green. This signifies that the signal SG0 can be calculated almost accurately by the subtraction method.

Alternatively, the DSP 110 may calculate the fourth electric signal SG using a division method instead of the subtraction method. For example, the DSP 110 can calculate the signal SG using the following equation 4.

SG=SW×(SW×Kg/(Kr×SR+Kb×SB)−1) (Equation 4)

A method using the equation 4 will be referred to as “division method” hereinafter. With the division method, the DSP 110 multiplies the second electric signal SR and the third electric signal SB by the coefficient Kr obtained in view of the spectral transmittance of the first filter and the coefficient Kb obtained in view of the spectral transmittance of the second filter, respectively. Furthermore, the DSP 110 adds up multiplication results, divides the first electric signal SW by a result of this addition (Kr×SR+Kb×SB), and subtracts 1 from a result of this. Then, the DSP 110 multiplies a result of this subtraction by the first electric signal SW. As a result, the signal SG is calculated.

By executing this division method, the signal SG2 shown in FIG. 5 can be obtained. The signal SG2 almost coincides with the signal SG0 in the wavelength range of green. This signifies that the signal SG0 can be calculated almost accurately by this division method.

The coefficients Kr, Kg, and Kb can be all set to 1 to simplify calculation. If so, the equation 3 is simplified to equation 5, and the equation 4 is simplified to equation 6. The DSP 110 can calculate the signal SG using the equations 5 and 6. The equations 5 and 6 are relatively simple although they are less accurate than the equations 3 and 4.

SG=SW−SR−SB (Equation 5)

SG=SW×(SW/(SR+SB)−1) (Equation 6)

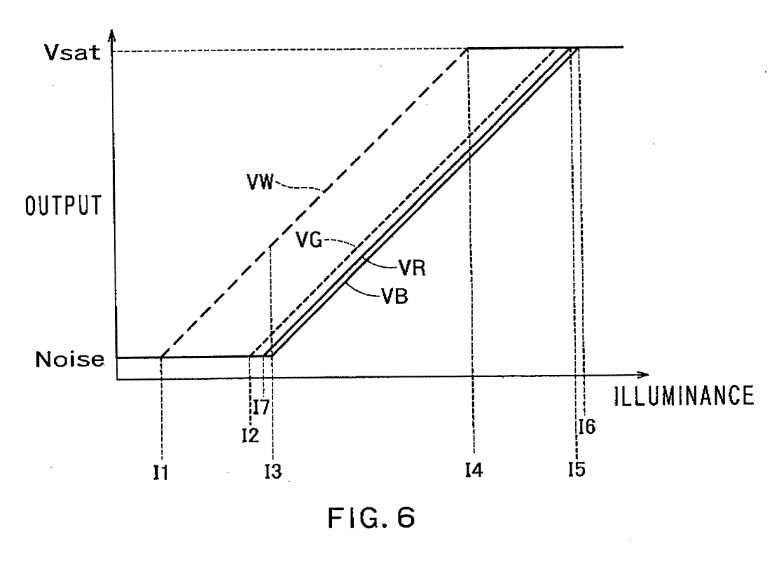

According to a graph shown in FIG. 6, an output VW from the pixel W, an output VR from the pixel R, and an output VB from the pixel B is not saturated and are higher than noise level in an illuminance range of I3 to I4. The DSP 110 can, therefore, calculate the signal SG using one of the equations 3 to 6.

However, as indicated by the output VW, if the illuminance exceeds I4, the output VW from the pixel W is saturated. As indicated by the output VB, if the illuminance is lower than I3, the output VB is lower than the noise level. Namely, the solid-state imaging device 100 according to the first embodiment can calculate the signal SG using one of the equations 3 to 6 in the illuminance range of I3 to I4. However, if the illuminance is lower than I3 or exceeds I4, the solid-state imaging device 100 cannot calculate the signal SG only by using one of the equations 3 to 6. On the other hand, the conventional solid-state imaging device using the pixels R, G, and B can detect the signals SR, SG, and SB in the illuminance range of I3 to I5 as can be understood from the outputs VR, VG, and VB shown in FIG. 6.

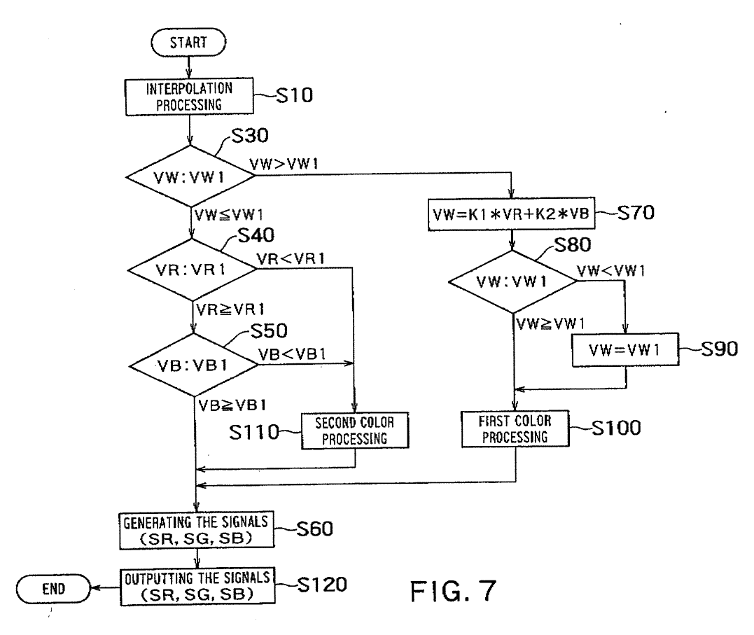

In the first embodiment, therefore, the DSP 110 performs calculation shown in FIG. 7 in the low illuminance range lower than I3 and the high illuminance range higher than I4. First, the DSP 110 performs the interpolation processing using the signals obtained from the imaging region 101 (S10). The DSP 110 can thereby obtain the signals SW, SR, and SB for the respective pixels. The outputs VW, VR, and VB shown in FIG. 6 correspond to voltages of the signals SW, SR, and SB, respectively.

The output VW of the signal SW is compared with a preset saturation value VW1 (S30). The saturation value VW1 is a preset output of the pixel W at the illuminance I4. If the output VW is equal to or lower than the saturation value VW1, it is clear that the outputs VW, VR, and VB are all equal to or lower than saturation levels. Namely, it is known that the illuminance of the incident light is equal to or lower than I4. If the output value VW is equal to or lower than the saturation value VW1, the illuminance VR of the signal SR is then compared with a noise level VR1 (S40). The noise level VR1 is a preset output of the pixel R at an illuminance I7. If the output VR is equal to or higher than the saturation value VR1, the illuminance VB of the signal SB is then compared with a noise level VB1 (S50). The noise level VB1 is a preset output of the pixel B at the illuminance I3. If the output VB is equal to or higher than the saturation value VB1 at the step 550, it is clear that the outputs VW, VR, and VB are all equal to or higher than the noise level VB1. Namely, it is clear that the illuminance of the incident light is equal to or higher than I3. In this case, the illuminance of the incident light is within a range of I3 to I4. The DSP 110 can, therefore, calculate the signal SG using the equations 3 to 6. The signals SR, SG, and SB can be thereby generated (S60). The signals SR, SG, and SB are then output from the solid-state imaging device 100 (S120).

If the output VW exceeds the saturation value VW1 at the step S30, it is known that the output VW exceeds the saturation level. Namely, it is clear that the illuminance of the incident light exceeds I4. In this case, the DSP 110 calculates the output VW by the following equation 7 (S70).

VW−K1×VR+K2×VB (Equation 7).

In the equation 7, coefficients K1 and K2 are constants set in view of the relation among the outputs VW, VR, and VB when white light, for example, is used as the incident light in the illuminance range of I3 to I4. As shown in the equation 7, the output VW can be expressed by a primary function of the outputs VR and VB. By calculating the equation 7, the output VW corresponding to the illuminance of the light incident on the pixel W in a saturation state can be obtained. In FIG. 6, the illuminance and the output are expressed in logarithmic scale. If the illuminance exceeds I6 and the outputs VR and VB reach saturation level, then the output VW cannot be calculated accurately by the equation 7 but is saturated. However, since the illuminance equal to or higher than I5 is the saturation level in the conventional technique, no problem occurs even if the output VW is saturated at the illuminance equal to or higher than I6.

The output VW obtained by the equation 7 is compared with the saturation value VW1 (S80). If the output VW is saturated due to high illuminance of the green light, the output VW cannot be accurately calculated by the equation 7. At the step S80, therefore, the DSP 110 determines whether a cause for the saturation of the output VW is the high illuminance of the green light. If the output VW obtained by the equation 7 is equal to or higher than the saturation value VW1, the output VW is saturated by the visible light, red light or blue light (which may include the green light). In this case, the DSP 110 performs a first color processing (S100). If the output VW obtained by the equation 7 is lower than the saturation value VW1, the output VW is saturated by the green light other than the visible light, red light or blue light. In this case, it is considered that the saturation value VW1 is closer to the actual VW than the output VW obtained by the equation 7. The DSP 110, therefore, substitutes the saturation value VW1 for the output VW (S90), and performs the first color processing.

In the first color processing (S100), color information on a certain replacement-target pixel is replaced by color information on a nearest unsaturated pixel. For example, the DSP 100 substitutes color information (outputs VWp, VRp, and VBp) on pixels, in which the output VW is not saturated and which are adjacent laterally to the replacement-target pixel in which the output VW is saturated, to the following equation 8. Calculated VW′, VR′, and VB′ are set as color information on the replacement-target pixel. In this case, the DSP 110 uses the color information on the replacement-target pixel as color information on a pixel read just before the replacement-target pixel in a certain row in the imaging region 101.

VW′=(VW/VWp)×VWp

VR′=(VW/VWp)×VRp

VB′=(VW/VWp)×VBp (Equation 8)

At the step S60, the DSP 110 substitutes the color information (VW′, VR′, and VB′) on the replacement-target pixel after replacement to the equation 3 for the signals SW, SR, and SB, respectively, thereby calculating the signal SG. Calculated signal SG corresponds to the fourth electric signal VG′ of the replacement-target pixel. As a result, color information on the replacement-target pixel (VR′, VG′, VB′) is obtained.

Alternatively, the DSP 110 can replace the color information on the replacement-target pixel by color information on a pixel vertically adjacent to the replacement-target pixel. In this case, the DSP 110 stores a row read just before the certain row in the imaging region 101 in a memory (not shown), and replace the color information on the replacement-target pixel by color information on the pixel adjacent back and forth to the replacement-target pixel.

More specifically, the DSP 110 performs an operation for adjusting the illuminance of the color information on the pixels, which are adjacent back and forth and around to the replacement-target pixel, to that of the replacement-target pixel. The DSP 110, then, replaces an operation result as the color information on the replacement-target pixel. For example, the color information on the replacement-target pixel is (VW′, VR′, and VB′), and respective color information on the visible light, red light, and blue light of the pixel adjacent back and forth and around to the replacement-target pixels are (VWp, VRp, and VBp). In this case, the DSP 110 performs a color replacement processing by calculating the equations 8 and 3 (or 4). If the VW is saturated in a plurality of laterally continuous pixels, the color replacement processing is performed on the VW-saturated pixel to which saturation occurs first while reading the signals at time series. On the subsequent VW-saturated pixels, the color replacement processing is performed using the pixel signal that has been just subjected to the color replacement processing. The same thing is true if the VW is saturated in a plurality of pixels adjacent back and forth.

In another alternative, the DSP 110 can calculate the SG while the color information on each pixel is made achromatic. For example, at high illuminance exceeding I4 or low illuminance lower than I3, recognition rate of human vision with respect to color information is reduced. Due to this, it often suffices to provide only luminance information on an achromatic color. In this case, the color information on the achromatic color can be calculated. It is rather preferable to calculate the color information on the achromatic color because the burden of the DSP 110 can be reduced. More specifically, the DSP 110 first makes a calculation as expressed by Equation 9.

VW′=(VW/W0)×W0

VR′=(VW/W0)×R0

VB′=(VW/W0)×B0 (Equation 9)

In the equation 9, (W0, R0, B0) indicate constants preset according to spectral transmissions of the colorless filter 10, the first filter 20, and the second filter 30, respectively. In the equation 9, luminances of (R0, G0, B0) are adapted to the output VW. It is to be noted that an achromatic signal (R0, G0, B0) is a signal that satisfies R0:G0:B0=1:1:1.

At the step S60, (VW′, VR′, VB′) are substituted to the equation 3 (or 4) for (SW, SR, SB), thereby obtaining the fourth electric signal VG′ of the replacement-target pixel as the signal SG. The (VR′, VG′, VB′) thus obtained are set as outputs of the replacement-target pixel. Since the calculation of the equation 9 is simpler than that of the equation 8, the calculation for the achromatic color does not impose load on the DSP 110. After performing the first color processing, the DSP 110 generates signals SR, SG, and SB as shown in the step S60.

Alternatively, sine the achromatic color satisfies R0:G0:B0=1:1:1, it is clear that the outputs (VR′, VG′, and VB′) satisfy (VR′, VG′, VB′)=1:1:1. Accordingly, the DSP 110 may calculate only one of VR′=(VW/W0)×R0 or VB′=(VW/W0)×B0 in the equation 9. For example, the DSP 110 can calculate VR′=(VW/W0)×R0 and applies the calculation result to VB′ and VG′. It is thereby unnecessary to make calculation based on the equation 3 (or 4). That is, the signals (SR, SG, SB) can be output at step S120 without executing the step S60 shown in FIG. 7.

On the other hand, if the output VR is lower than the noise level VR1 at the step S40 or the output VB is lower than the noise level VB1 at the step S50, the DSP 110 performs a second color processing (S110). As the second color processing, the DSP 110 can perform either the replacement processing using the equation 8 or the achromatic color processing using the equation 9. However, the second color processing may be different from the first color processing. For example, the first color processing may be the replacement processing using the equation 8 whereas the second color processing may be the achromatic color processing using the equation 9 or vice versa.

For example, at illuminance I1 to I3, the output VW from the first pixel W is equal to or higher than the noise level but the output VR from the second pixel R is lower than the noise level due to the low illuminance. In this case, the DSP 110 calculates the equation 8 as the second color processing by using the outputs VW, VR, and VB from the pixels which is near the second pixel R and in which the outputs VR and VB are equal to or higher than the noise level. At this time the output VW from this second pixel R is used. Thus, the outputs (VW′, VR′, VB′) from the second pixel R can be obtained.

Alternatively, the DSP 110 can perform the second color processing by making the color information on the pixel achromatic color information. For example, by applying a new first electric signal SW (output VW) for the second pixel R obtained by the interpolation processing to the equation 9, outputs (VW′, VR′, VB′) are obtained.

After performing the second processing, the DSP 110 generates the signals SR, SG, and SB as shown in the step S60. By performing the second color processing, even if the illuminance of the incident light is I3 or lower, the signals SR, SG, and SB can be obtained.

As stated above, the conventional device can detect the incident light in the illuminance range of I3 to I5. The solid-state imaging device 100 according to the first embodiment can detect the incident light in the illuminance range of I1 to I6 by performing the interpolation processing (S10), the processing for calculating the output VW (S70), and the first and second color processings (S100 and S110). Namely, according to the first embodiment, the incident light at low illuminance equal to or lower than I3 can be detected.

As stated so far, the solid-state imaging device 100 according to the first embodiment incorporates the colorless pixel W including the colorless filter that can use 95% or more of the incident light energy, and dispenses with the pixel G including a monochromatic color filter low in utilization efficiency of the incident light energy. By incorporating the pixel W high in utilization efficiency of the incident light energy in place of the pixel G low in utilization efficiency thereof, the solid-state imaging device 100 according to the first embodiment can acquire three types of color information (R, G, and B) while improving the utilization efficiency of the incident light energy. That is, by incorporating the pixel W high in utilization efficiency of the incident light energy in place of the pixel G low in utilization efficiency thereof, incident light at low illuminance can be detected at high sensitivity. This can further miniaturize the entire device.

In the first embodiment, the pixel G has been dispensed with. However, the pixel B can be dispensed with in place of the pixel G. This is because the utilization efficiency of the incident light energy of the pixel B is almost equal (about 80%) to that of the pixel G.

### Second Embodiment

The same signal processing as that according to the first embodiment can be applied even to the instance of so-called YUV outputs in place of RGB outputs. In a second embodiment, the first embodiment is applied to the YUV outputs. A solid-state imaging device according to the second embodiment can be identical in configuration to that according to the first embodiment.

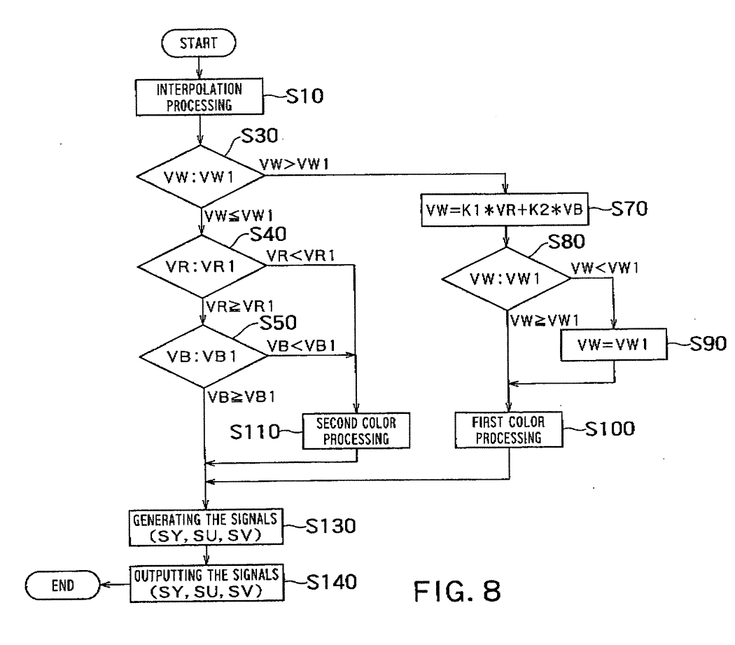

As shown in FIG. 8, according to the second embodiment, the step of generating the signals SR, SG, ad SB shown in FIG. 7 (S60) is replaced by a step of generating signals SY, SU, and SV (S130). The step of outputting the signals SR, SG, and SB shown in FIG. 7 (S120) is replaced by a step of generating the signals SY, SU, and SV (S140). Moreover, the second embodiment differs in achromatic color processing from the first embodiment.

The signals SY, SU, and SV are generated at the step S130 as follows.

The luminance signal SY is expressed by the following equation 10.

SY=0.30×SR+0.59×SG+0.11×SB (Equation 10)

Since the CFA in the second embodiment does not include the pixels G, the DSP 110 calculates the signals SY, SU, and SV from the signals SW, SR, and SB for the respective pixels obtained by the interpolation processing. To do so, the DSP 110 can obtain the signal SY as expressed by the following equation 11 using the equations 3 and 10.

SY=0.30×SR+0.58×(0.82×SW−0.84×SR−SB)+0.11×SB=0.48×W−0.19×R−0.47×B (Equation 11)

Furthermore, the color-difference signals SU and SV can be expressed by equations 12 and 13, respectively.

SU=0.492×(SB−SY)=0.492×(0.53×SB+0.19×SR−0.48×SW)=0.26×SB+0.09×SR−0.24×SW (Equation 12)

SV=0.877×(SR−SY)=0.877×(0.52×SR+0.47×SB−0.48×SW)−0.46×SR+0.41×SB−0.42×SW (Equation 13)

To perform the achromatic color processing, the signals SU and SV can be set to zero (SU, SV)=(0, 0). The second embodiment exhibits the same advantage as that of the first embodiment in that the incident light at lower illuminance than that according to the conventional technique can be detected.

### Third Embodiment

In a third embodiment, either the signal SW or a signal after interpolation is used as it is as the luminance signal SY. The other constituent elements and processings according to the third embodiment can be identical to those according to the second embodiment.

The luminance signal SY and the color-difference signals SU and SV can be expressed by the following equations 14 to 16, respectively.

SY=SW (Equation 14)

SU=0.492×(SB−aSY) (Equation 15)

SV=0.877×(SR−bSY) (Equation 16)

### In the equations 14, 15, and 16, symbol “a” and “b” indicate constants set by spectral transmittances of a blue-transmittable filter and a red-transmittable filter, and a spectral sensitivity of a photodiode.

According to the third embodiment, the processing for generating the signals SY, SU, and SV (S130) is simplified. Therefore, the load on the DSP 110 can be reduced. Moreover, since the signal SW is directly used as the signal SY, the S/N ratio of the luminance signal SY is improved.

### (Modifications of Pixel Arrangement)

Modifications of a pixel arrangement in the imaging region 101 will next be described.

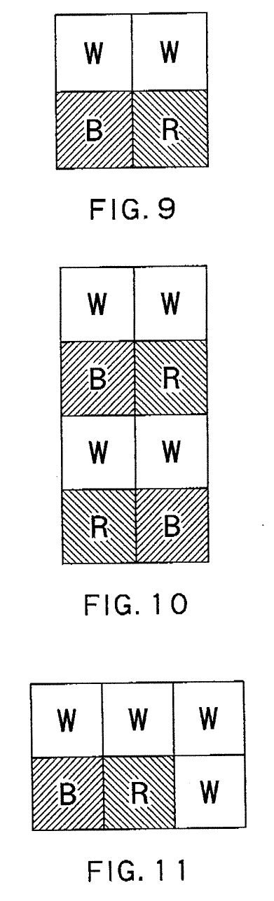

FIG. 9 is a schematic showing a pixel arrangement of a four-pixel block in two rows by two columns in which two pixels W are arranged in row direction and in which one pixel R and one pixel B are arranged in the row direction according to one modification of the present invention. By repeatedly arranging these four-pixel blocks, the pixels W are arranged in the form of stripes in the row direction. The pixel R or B is repeatedly arranged between adjacent rows of the pixels W. According to this modification, the DSP 110 can calculate the signal SG similarly to the first to third embodiments. This modification can, therefore, exhibit the same advantages as those of the first to third embodiments. Furthermore, in the pixel array shown in FIG. 9, only the row of pixels W can be selectively read using features of the CMOS sensor that reads signals in rows. It is thereby possible to pick up a high-sensitivity image at high frame rate despite a monochromatic image.

FIG. 10 is the same in arrangement as FIG. 9 in that the pixels W are arranged in the form of stripes. In the arrangement shown in FIG. 9, the pixels in a certain column are arranged in order of W, R, W, R . . . or W, B, W, B. . . . In the arrangement shown in FIG. 10, by contrast, the pixels in a certain column are arranged in order of W, B, W, R . . . or W, R, W, B. . . . As can be seen, in the modification shown in FIG. 10, the pixel region is constituted with an eight-pixel block in four rows by two columns set as a unit. The modification shown in FIG. 10 exhibits the same advantages as those of the modification shown in FIG. 9. Moreover, in the modification shown in FIG. 10, since the pixels R and B are alternately arranged, color resolutions of the signals SR and SB are improved.

FIG. 11 is the same in arrangement as FIG. 9 in that the pixels W are arranged in the form of stripes. In the arrangement shown in FIG. 11, the pixels R, B, and W are repeatedly arranged between the adjacent rows of the pixels W. As can be seen, in the modification shown in FIG. 11, the pixel region is constituted with a six-pixel block in two rows by three columns set as a unit. The modification shown in FIG. 11 exhibits the same advantages as those of the modification shown in FIG. 9. Moreover, in the modification shown in FIG. 11, a color image can be picked up at high frame rate by reading only the row including the pixels R, B, and W.

FIG. 12 is the same in arrangement as FIG. 9 in that the pixels W are arranged in the form of stripes. In the arrangement shown in FIG. 12, the pixels are repeatedly arranged between the adjacent rows of the pixels W in order of W, R, W, B . . . or W, B, W, R. . . . As can be seen, in the modification shown in FIG. 12, the pixel region is constituted with a 16-pixel block in four rows by four columns set as a unit. The modification shown in FIG. 12 exhibits the same advantages as those of the modification shown in FIG. 9. In the modification shown in FIG. 12, a color image can be picked up at high frame rate by reading only the row including the pixels R, B, and W. Furthermore, in the modification shown in FIG. 12, a ratio of the pixels in one unit is as high as 75% as compared with the modification shown in FIG. 11. In the modification shown in FIG. 12, therefore, an image can be picked up at higher sensitivity under ordinary imaging conditions.

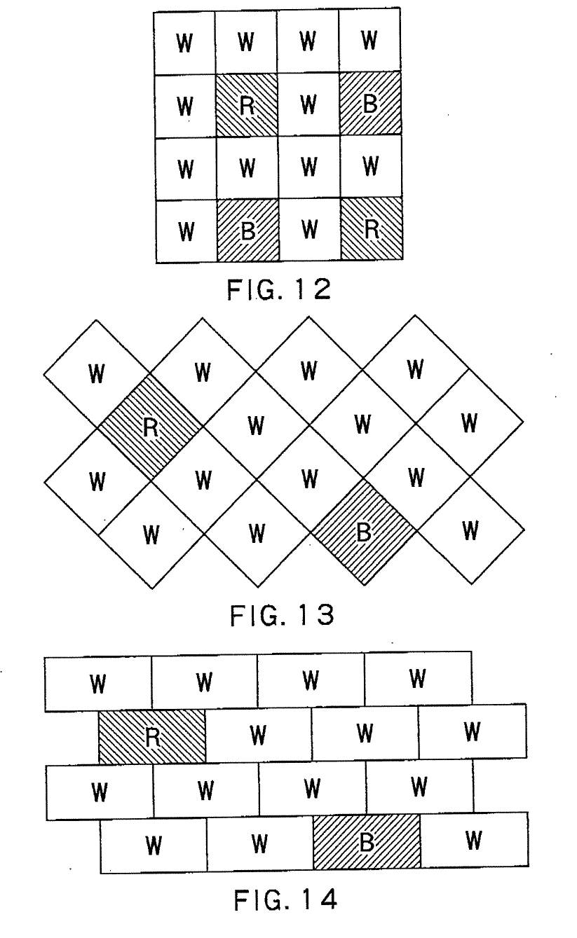

In FIG. 13, a pixel is formed in the form of a rectangle on a semiconductor substrate. The pixel is, however, arranged so that sides are inclined with respect to arrangement direction of the pixels W, R, and B. More specifically, each pixel is formed into a square inclined by 45 degrees with respect to longitudinal and lateral axes of an imaging surface. The adjacent pixels in the imaging region 101 are arranged without gaps. The pixels W are arranged in row direction in the form of stripes, and the pixels W, R, and B are repeatedly arranged between rows of the pixels W. The pixel region shown in FIG. 13 is constituted with a 16-pixel block in four rows by four columns set as a unit.

The modification shown in FIG. 13 exhibit the same advantages as those of the modification shown in FIG. 9. Moreover, in the modification shown in FIG. 13, since a ratio of pixels W in one unit is as high as 87.5% in ordinary imaging mode, an image can be picked up at extremely high sensitivity.

In FIG. 14, each pixel is in the form of a rectangle a width of which is twice as large as a height. Adjacent pixel-rows are arranged to be shifted by half-pitch. The pixels W are arranged in every other row in row direction in the form of stripes. The pixels W, R, and B are repeatedly arranged between the adjacent rows of the pixels W. In the modification shown in FIG. 14, the pixel region is constituted with a 16-pixel block in four rows by four columns set as a unit. The modification shown in FIG. 14 exhibits the same advantages as those of the modification shown in FIG. 9. Moreover, in the modification shown in FIG. 14, an image can be picked up at extremely high sensitivity the ratio of pixels W in one unit is high in ordinary imaging mode similarly to the modification shown in FIG. 13.

In a solid-state imaging device using the pixel arrangement shown in any one of FIGS. 10 to 14, a wider pixel block than that in three rows by three columns is necessary to perform an interpolation processing. The DSP 110, therefore, needs to perform a weighted averaging processing in view of the distance between a pixel to be interpolated and a pixel that outputs data used in the interpolation, when performing the interpolation processing.

An IR-cut filter can be provided in each of the pixels R and B other than the pixel W. By doing so, the pixels R and B can detect more accurate signals without receiving near-infrared light. Moreover, since the pixel W detects the near-infrared light, an image can be picked up at higher sensitivity.

In the embodiments, the CFA is constituted by the combination of the pixels W, R, and B. However, as the pixels R and B among the pixels W, R, and B, desired two colors can be selected from among the three primary colors of light, i.e., R, G, and B.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A solid-state imaging device comprising:
a plurality of first pixels each including a colorless filter substantially transmitting a visible light at all wavelengths to convert the visible light into a first electric signal;
a plurality of second pixels each including a first filter having a peak of a spectral transmission at a first wavelength of the visible light to convert the visible light at the first wavelength into a second electric signal;
a plurality of third pixels each including a second filter having a peak of a spectral transmission at a second wavelength other than the first wavelength of the visible light to convert the visible light at the second wavelength into a third electric signal; and
an arithmetic part calculating a fourth electric signal corresponding to a third wavelength other than the first wavelength and the second wavelength by using the first to the third electric signals.

2. The device according to claim 1, wherein the first wavelength and the second wavelength are wavelengths of two colors out of three primary colors of light.

3. The device according to claim 1, wherein the arithmetic part multiplies the second electric signal by a coefficient decided by a spectral transmittance of the first filter and multiplies the third electric signals by a coefficient decided by a spectral transmittance of the second filter,
the arithmetic part subtracts results of the multiplications from the first electric signal to obtain the fourth electric signal.

4. The device according to claim 1, wherein the arithmetic part multiplies the second electric signal by a coefficient decided by a spectral transmittance of the first filter and multiplies the third electric signals by a coefficient decided by a spectral transmittance of the second filter,
the arithmetic part adds up results of the multiplications,
the arithmetic part divides the first electric signal by a result of the addition of the results of the multiplications,
the arithmetic part subtracts 1 from a result of the division of the first electric signal by a result of the addition, and
the arithmetic part multiplies the first electric signal by a result of the subtraction of 1 from the result of the division to obtain the fourth electric signal.

5. The device according to claim 1, wherein the arithmetic part interpolates the second electric signal at the first wavelength for one of the first pixels by using the second electric signal obtained from the second pixel adjacent to the first pixel and interpolates the third electric signal at the second wavelength for one of the first pixels by using the third electric signal obtained from the third pixel adjacent to the first pixel,
the arithmetic part interpolates the first electric signal at the visible light for one of the second pixels by using the first electric signal obtained from the first pixel adjacent to the second pixel and interpolates the third electric signal at the second wavelength for one of the second pixels by using the third electric signal obtained from the third pixel adjacent to the second pixel,
the arithmetic part interpolates the first electric signal at the visible light for one of the third pixel by using the first electric signal from the first pixel adjacent to the third pixel and interpolates the second electric signal at the first wavelength for one of the third pixel by using the second electric signal from the second pixel adjacent to the third pixel, and
the arithmetic part calculates the fourth electric signal by using the first to the third electric signals interpolated for each pixel.

6. The device according to claim 1, wherein a pixel region is constituted by periodically repeating units, each of the units being a four-pixel block including two first pixels, one second pixel, and one third pixel.

7. The device according to claim 1, wherein the first pixels are arranged into stripes in every other row, and
the second and the third pixels are alternately arranged between adjacent rows of the first pixels.

8. The device according to claim 1, wherein the first pixels are arranged into stripes in every other row, and
the first to the third pixels are alternately and repeatedly arranged between adjacent rows of the first pixels.

9. The device according to claim 1, wherein the first pixels are arranged into stripes in every other row, and
the first to the third pixels are repeatedly arranged between adjacent rows of the first pixels in order of one of the first pixel, one of the second pixels, one of the first pixels, and one of the third pixels.

10. The device according to claim 1, wherein each of the first to the third pixels are formed into rectangles, and arranged so that sides are inclined with respect to arrangement directions of the first to third pixels.

11. The device according to claim 1, wherein the second and third pixels include infrared-cut filters cutting a near-infrared light.

12. A solid-state imaging device comprising:
a plurality of first pixels each including a colorless filter substantially transmitting a visible light at all wavelengths to convert the visible light into a first electric signal;
a plurality of second pixels each including a first filter having a peak of a spectral transmission at a first wavelength of the visible light to convert the visible light at the first wavelength into a second electric signal;
a plurality of third pixels each including a second filter having a peak of a spectral transmission at a second wavelength other than the first wavelength of the visible light to convert the visible light at the second wavelength into a third electric signal; and
an arithmetic part receiving the first to the third electric signals generated by a light incident on a pixel region constituted by the first pixels to the third pixels, the arithmetic part generating a luminance signal and a color-difference signal for one of the first to the third pixels by using the first to the third electric signals.

13. The device according to claim 12, wherein the arithmetic part interpolates the second electric signal at the first wavelength for one of the first pixels by using the second electric signal obtained from the second pixel adjacent to the first pixel and interpolates the third electric signal at the second wavelength for one of the first pixels by using the third electric signal obtained from the third pixel adjacent to the first pixel,
the arithmetic part interpolates the first electric signal at the visible light for one of the second pixels by using the first electric signal obtained from the first pixel adjacent to the second pixel and interpolates the third electric signal at the second wavelength for one of the second pixels by using the third electric signal obtained from the third pixel adjacent to the second pixel,
the arithmetic part interpolates the first electric signal at the visible light for one of the third pixel by using the first electric signal from the first pixel adjacent to the third pixel and interpolates the second electric signal at the first wavelength for one of the third pixel by using the second electric signal from the second pixel adjacent to the third pixel, and
the arithmetic part calculates the fourth electric signal by using the first to the third electric signals interpolated for each pixel, the fourth electric signal being used to generate the luminance signal and the color-difference signal.

14. The device according to claim 12, wherein the arithmetic part uses, as the luminance signal, the first electric signal after interpolation.

15. The device according to claim 13, wherein when the first electric signal from one of the first pixels exceeds a predetermined value due to high illuminance, the arithmetic part calculates the first electric signal to the third electric signal for one of the first pixels by using the second electric signal and the third electric signal for one of the first pixels and by using the first electric signal to the third electric signal for one of the pixels which is adjacent to the one of the first pixels and in which the first electric signal is equal to or lower than the predetermined value, and
the arithmetic part calculates a fourth electric signal for the one of the first pixels using the calculated first to third electric signals.

16. The device according to claim 13, wherein when an output from the one of the first pixels exceeds a predetermined value due to high illuminance, the arithmetic part calculates the first electric signal to the third electric signal for one of the first pixels by using the second and the third electric signals for the one of the first pixels, and by using constants decided based on a spectral transmittance of the colorless filter, a spectral transmittance of the first filter, and a spectral transmittance of the second filter so that a ratio of the second electric signal, the third electric signal, and the fourth electric signal satisfies 1:1:1, and
the arithmetic part calculates the fourth electric signal by using the calculated first to the third electric signals.

17. The device according to claim 13, wherein when an output from the one of the first pixels exceeds a predetermined value due to high illuminance, the arithmetic part calculates the second or the third electric signal for the one of the first pixels by using the second and the third electric signals for one of the first pixels, and by using constants decided based on a spectral transmittance of the colorless filter, a spectral transmittance of the first filter, and a spectral transmittance of the second filter so that a ratio of the second electric signal, the third electric signal, and the fourth electric signal satisfies 1:1:1, and
the arithmetic part calculates the fourth electric signal by using the calculated second or the third electric signal.

18. The device according to claim 13, wherein when the second electric signal from the one of the second pixels or the third electric signal from the one of the third pixels is lower than a predetermined value due to low illuminance, the arithmetic part calculates the first electric signal to the third electric signal for the one of the second or one of the third pixels by using the first to the third electric signals from one of the pixels which is adjacent to one of the second or the third pixels and in which the second and the third electric signals are equal to or higher than the predetermined value, and by using constants decided based on a spectral transmittance of the colorless filter, a spectral transmittance of the first filter, and a spectral transmittance of the second filter, and
the arithmetic part calculates the fourth electric signal by using the calculated first to the third electric signals.

19. The device according to claim 5, wherein when an output from one of the second or one of the third pixels is lower than a predetermined value due to low illuminance, the arithmetic part calculates the first electric signal to the third electric signal for the one of the second or the one of the third pixels by using the first electric signal for the one of the second or the one of third pixels, and by using constants decided based on a spectral transmittance of the colorless filter, a spectral transmittance of the first filter, and a spectral transmittance of the second filter so that a ratio of the second electric signal, the third electric signal, and the fourth electric signal satisfies 1:1:1, and
the arithmetic part calculates the fourth electric signal by using the calculated first to third electric signals.

20. The device according to claim 13, wherein when an output from one of the second or one of the third pixels is lower than a predetermined value due to low illuminance, the arithmetic part calculates the second or the third electric signal for the one of the second or the one of the third pixels by using the first electric signal for the one of the second or the one of the third pixels, and by using constants decided based on a spectral transmittance of the colorless filter, a spectral transmittance of the first filter, and a spectral transmittance of the second filter so that a ratio of the second electric signal, the third electric signal, and the fourth electric signal satisfies 1:1:1, and
the arithmetic part calculates the fourth electric signal using the calculated second or third electric signals.
